(19) United States
(12) Patent Application Publication
(10) Pub. No.: US 2006/0245827 A1
(43) Pub. Date: Nov. 2, 2006

(54) Conformable and removable tactile warning mat systems

(76) Inventors: Richard W. Rydin, Chapel Hill, NC (US); Robert J. Scrima JR., Henderson, NV (US)

Correspondence Address: MYERS BIGEL SIBLEY & SAJOVEC, PO BOX 37428, RALEIGH, NC, 27627, US

(21) Appl. No.: 11/398,227

(22) Filed: Apr. 5, 2006

Related U.S. Application Data
(60) Provisional application No. 60/668,498, filed on Apr. 6, 2005.

(51) Int. Cl. E01F 9/00; E01F 11/00; E01C 5/00; G01D 13/22

(52) U.S. Cl. 404/9; 404/15; 404/39; 404/42; 116/205

(57) ABSTRACT

A tactile warning mat system includes a tactile warning mat and a plurality of elongated underlayment laths removably secured to the tactile warning mat via fasteners. The warning mat includes opposite upper and lower surfaces. The upper surface of the warning mat includes a plurality of raised projections that extend outwardly therefrom in a tactile pattern, The warning mat also includes a plurality of apertures formed therethrough. The elongated underlayment laths are removably secured to the tactile warning mat lower surface in spaced-apart relationship. The underlayment laths are adapted to be embedded within an uncured walkway surface material and each underlayment lath has a cross-sectional configuration that locks the underlayment lath within the walkway surface material when cured. Each underlayment lath includes at least one fastener receiving passageway that terminates at the underlayment lath upper surface and that is configured to removably receive a respective fastener therein.

### RELATED APPLICATION

This application claims the benefit of and priority to U.S. Provisional Patent Application No. 60/668,498, filed Apr. 6, 2005, the disclosure of which is incorporated herein by reference as if set forth in its entirety.

### FIELD OF THE INVENTION

The present invention relates generally to pedestrian walkways, platforms, and the like and, more particularly, to tactile warning mats which assist pedestrians, particularly those who are blind or visually impaired, in following a walkway or in detecting the location of a walkway edge, platform edge or other hazard.

### BACKGROUND OF THE INVENTION

The Americans with Disabilities Act (ADA) Accessibility Guidelines for Buildings and Facilities (the ADA guidelines) established recommendations for detectable, tactile warning surfaces for use on curb ramps, walking surfaces, transit platforms and other locations where visually handicapped persons would benefit from a warning of potential hazards. The ADA guidelines require warning surfaces to include raised domes or bumps having a nominal diameter, height and separation distance, and require warning surfaces to contrast visually with adjoining surfaces. The ADA guidelines further require warning surfaces to differ from adjoining surfaces in resiliency or sound, for example when contacted by a visually impaired person's cane.

Examples of warning surfaces include warning mats used on walkways and other areas of pedestrian traffic to provide warning and direction for visually handicapped persons. Warning mats are traditionally bonded directly to a walking surface or cast in place during construction of a walking surface. In either case, it can be difficult to remove and replace installed warning mats (e.g., damaged warning mats) without extensive rework of the surrounding walkway surface.

U.S. Pat. No. 4,715,743 to Schmanski describes a polymeric plate with surface texture that is adhesively bonded directly to an underlying surface. U.S. Pat. No. 5,303,669 to Szekely describes a textured tile having tapered edges and an integral underlayment grid that permits embedment directly in wet concrete. U.S. Pat. No. 5,775,835 to Szekely describes adding truncated conical projections on the bottom surface of a textured tile to bridge gaps created by trapped air when setting a textured tile directly into wet concrete. Unfortunately, these conventional warning mats that are permanently attached to an underlying surface (e.g., a concrete surface) have a significant drawback. In the event a portion of a warning mat becomes damaged or worn out, the effort required to remove and replace the warning mat can be costly and time consuming.

U.S. Pat. No. 6,718,714 to Montgomery describes a removable safety flooring and anchor box assembly wherein the anchor box has a top surface that supports one or more tiles and one or more sidewalls for projecting into a cement ground substrate. Unfortunately, the proposed anchor box integral top produces an inherently stiff structure that is difficult to conform to curved substrates, which represent a majority of current walkway curb profiles.

### SUMMARY OF THE INVENTION

In view of the above discussion, tactile warning mat systems for walkways, curbs, and other areas of pedestrian traffic are provided. According to some embodiments of the present invention, a tactile warning mat system, includes a tactile warning mat and a plurality of elongated underlayment laths removably secured to the tactile warning mat in spaced-apart relationship via fasteners. The warning mat includes opposite upper and lower surfaces. The upper surface of the warning mat includes a plurality of raised projections (e.g., bumps, etc.) that extend outwardly therefrom in a tactile pattern, The warning mat also includes a plurality of apertures formed therethrough. The elongated underlayment laths are removably secured to the tactile warning mat lower surface in spaced-apart relationship and are adapted to be embedded within an uncured walkway surface material (e.g., concrete, asphalt, etc.). Each underlayment lath has a cross-sectional configuration that locks the underlayment lath within the walkway surface material when cured. Each underlayment lath includes at least one fastener receiving passageway that terminates at an upper surface thereof and that is configured to removably receive a respective fastener (e.g., bolt, screw, anchor, toggle bolt, clip, pin, retaining ring, etc.) therein. A plurality of fasteners extend through the tactile warning mat apertures and removably secure the tactile warning mat to the underlayment laths via the respective fastener receiving passageways.

According to some embodiments of the present invention, the underlayment laths have a lower surface with a contoured configuration that facilitates the removal of air trapped therebeneath when embedded within uncured walkway surface material.

According to some embodiments of the present invention, the warning mat includes a lip that extends outwardly from the warning mat lower surface adjacent a periphery thereof. The lip is configured to prevent the ingress of water beneath the tactile warning mat when the tactile warning mat system is installed in a walkway.

According to some embodiments of the present invention, a sealant material is disposed between and/or adjacent to the tactile warning mat lower surface and each underlayment lath to prevent the ingress of water therebetween.

According to some embodiments of the present invention, the warning mat may have a non-planar, contoured configuration that conforms to the curvature of a walkway surface.

According to some embodiments of the present invention, the underlayment laths may be interconnected to form a unitary structure. The unitary structure is removably secured to the tactile warning mat lower surface. The underlayment laths in the unitary structure are adapted to be embedded within an uncured walkway surface material, and each underlayment lath has a cross-sectional configuration that locks the underlayment lath within the walkway surface material when cured.

According to some embodiments of the present invention, a tactile warning mat system may include a plurality of warning mats and respective underlayment laths removably secured thereto as required by the surface area of a walkway to be covered.

Tactile warning mat systems according to embodiments of the present invention are advantageous over conventional warning mats because damaged and worn out warning mats can be replaced easily and inexpensively, and without causing damage to adjacent walkway surfaces. Moreover, warning mats according to embodiments of the present invention can be made to conform to the curved configuration of a walkway surface.

### BRIEF DESCRIPTION OF THE DRAWINGS

The accompanying drawings, which form a part of the specification, illustrate key embodiments of the present invention. The drawings and description together serve to fully explain the invention.

FIG. 1 is a perspective view of a tactile warning mat, according to some embodiments of the present invention.

FIG. 2 is an enlarged perspective view of a portion of the tactile warning mat of FIG. 1 that illustrates holes therein for attaching the mat to underlayment laths, according to some embodiments of the present invention.

FIGS. 3A-3D are cross-sectional views of four respective different underlayment laths, according to some embodiments of the present invention.

FIGS. 4A-4C are side elevation views of three respective different underlayment laths, according to some embodiments of the present invention.

FIG. 5 is a perspective view of an underlayment lath having an inverted keystone cross-section and a flat bottom profile, according to some embodiments of the present invention.

FIG. 6 is a perspective view of an underlayment lath having an inverted keystone cross-section and a sinusoidal bottom profile, according to some embodiments of the present invention.

FIG. 7 is a perspective view of a tactile warning mat system, according to some embodiments of the present invention, including a tactile warning mat removably attached to three discrete underlayment laths, and wherein each underlayment lath has an inverted keystone cross-section and a flat bottom profile.

FIGS. 8A-8B are perspective views of respective tactile warning systems wherein each tactile warning mat has a curved configuration to conform to the shape of various curved walking surfaces.

FIGS. 9A-9C are top plan views of three different unitary underlayment configurations, according to some embodiments of the present invention.

FIG. 10 is a perspective view of a tactile warning mat having a drop down perimeter edge lip to prevent water penetration therebeneath, and illustrating use of a sealant to prevent water ingress between the laths and warning mat, according to some embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of a warning mat system in use or operation in addition to the orientation depicted in the figures. For example, if the warning mat system in the figures is inverted, elements described as “under” or “beneath” other elements or features would then be oriented “over” the other elements or features. Thus, the exemplary term “under” can encompass both an orientation of “over” and “under”. The warning mat system may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

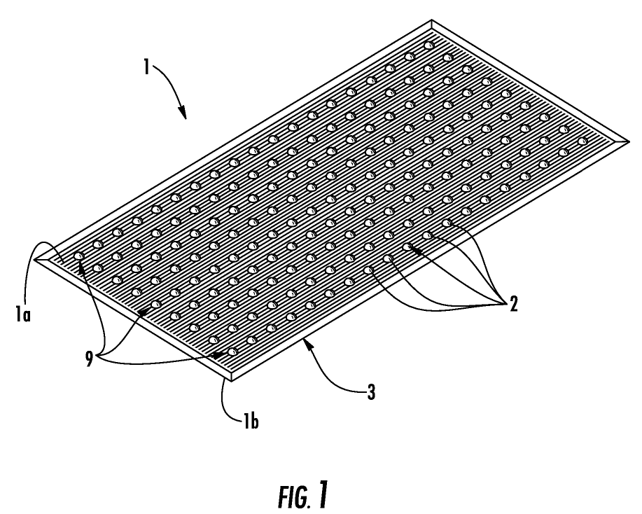

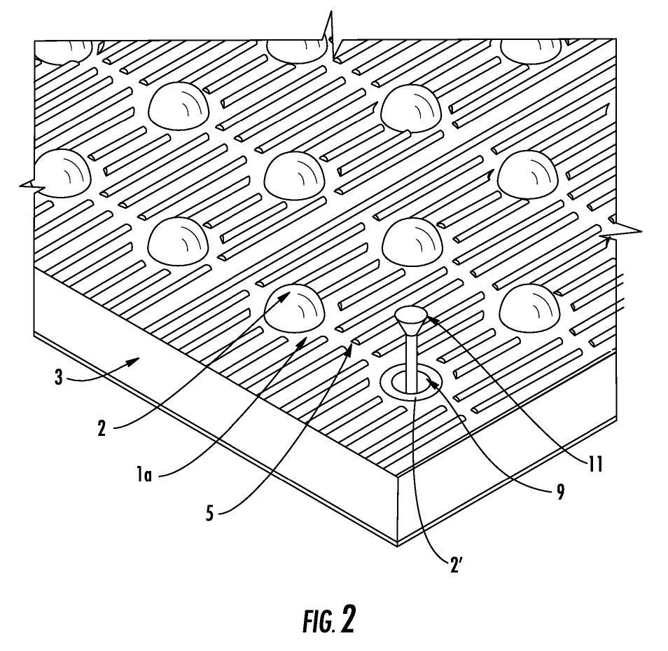

Referring now to FIGS. 1-2, a tactile warning mat 1, according to some embodiments of the present invention, is illustrated, and includes upper and lower surfaces 1a, 1b. The upper surface 1a includes an array of raised bumps 2 extending outwardly therefrom that create a warning surface. The size and spacing of the bumps 2 is stipulated within a narrow range by the ADA guidelines, as would be understood by one skilled in the art of the present invention. The bumps 2 as well as other portions of the mat upper surface 1a, may include texturing material (e.g., grit, etc.) that increases traction and/or tactility.

Tactile warning mats typically range in size from 2 feet by 4 feet up to 3 feet by 5 feet and can be up to an half inch thick. However, tactile warning mats of various sizes and configurations may be utilized in accordance with embodiments of the present invention.

The illustrated tactile warning mat 1 includes a beveled peripheral edge portion 3 that provides a smooth transition between the mat 1 and a surrounding walking surface. The illustrated tactile warning mat 1 also includes a plurality of substantially parallel, spaced-apart ridges 5 extending outwardly from the mat upper surface 1a, as illustrated. The illustrated ridges 5 extend along the length of the tactile warning mat 1 and are intended to provide additional traction in inclement weather. Moreover, the ridges 5 are spaced-apart from the bumps 2 so as to define a path for water to flow around the bumps 2, as illustrated. Select bumps 2′ (or bump locations) contain respective apertures 9 therethrough in order to permit the use of a fastener I1 (e.g., bolt, screw, anchor, toggle bolt, clip, pin, retaining ring, etc.) to attach the tactile warning mat 1 to an underlayment structure. Various types of fasteners may be utilized without limitation. The apertures 9 are preferably formed in locations of the warning mat 1 having an enhanced thickness and/or strength.

According to some embodiments of the present invention, tactile warning mats, such as illustrated in FIGS. 1-2, are configured to be removably secured to a plurality of spaced-apart, unconnected underlayment laths that are embedded within concrete, asphalt or other material, to form a tactile warning mat system. In order to ensure proper alignment, the plurality of underlayment laths are removably secured to a respective tactile warning mat prior to installation of the warning mat. To secure the combined system of warning mat and underlayment laths Within a surface, the underlayment laths (removably attached to a warning mat) are placed within wet (i.e., uncured, partially uncured, etc.) concrete, asphalt, or the like, to a depth sufficient for the warning mat to align properly (e.g., to be substantially flush, co-planar, etc.) with an adjacent mat and/or walkway surface. The surface material is then allowed to cure or harden such that the underlayment laths are securely retained by the cured or hardened material. This method of installation ensures that the separate, unconnected laths are properly positioned. The warning mat can then be easily removed from the underlayment laths, for repair, replacement, etc.

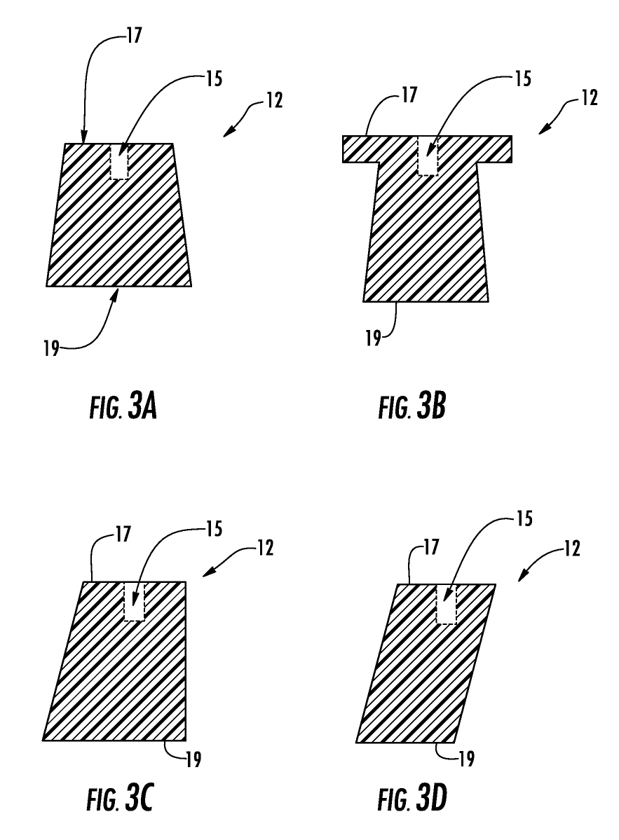

Referring to FIGS. 3A-3D, exemplary cross-sectional views of discrete underlayment laths 12 that may be used in accordance with some embodiments of the present invention are illustrated. For example, FIGS. 3A-3B illustrate various keystone cross-sectional configurations; FIG. 3C illustrates a trapezoid cross-sectional configuration; and FIG. 3D illustrates a parallelogram cross-sectional configuration.

Each illustrated underlayment lath 12 includes an upper and lower surface 17, 19 and one or more spaced-apart passageways 15 configured to receive a bolt or other type of fastener for securing a tactile warning mat 1 thereto. Each fastener receiving passageway 15 of an underlayment lath 12 may contain threads or may otherwise be configured to receive and retain a bolt or fastener, as would be understood by those skilled in the art. Embodiments of the present invention are not limited to a particular type or configuration of the fastener receiving passageways 15.

The four illustrated cross-sectional configurations of the underlayment laths 12 in FIGS. 3A-3D are merely representative of numerous configurations that will mechanically lock into a cured concrete, asphalt or other suitable walking surface substrate. Each of the illustrated lat cross-sectional configurations are such that the respective underlayment lath 12 cannot be removed in an upwardly direction from cured or hardened surface material. The width and depth of each underlayment lath 12 may vary, but shall be sufficient to support each fastener receiving passageway 15 without causing a material failure of the underlayment lath 12. The upper surface 17 of each underlayment lath 12 is preferably flat so as to maintain continuous contact with the bottom surface 1b of a tactile warning mat 1. The bottom surface 19 of an underlayment lath 12 may be flat or may have contours that allow trapped air to move out from thereunder during installation in wet concrete, asphalt or other walkway substrate material.

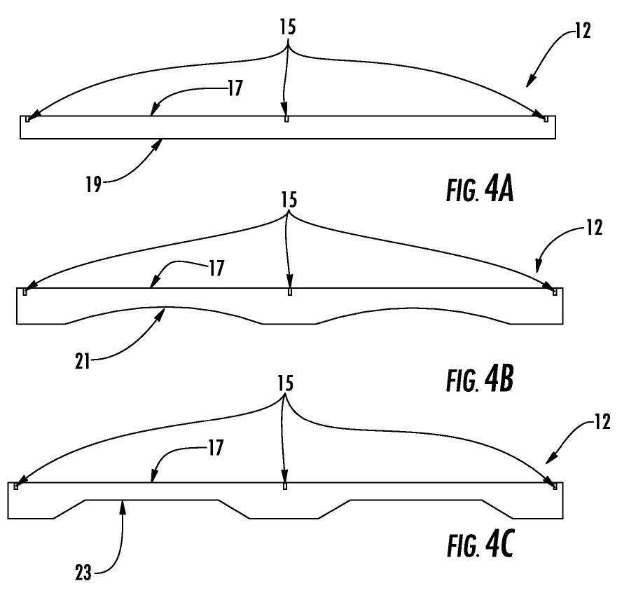

Referring to FIGS. 4A-4C, exemplary side elevational views of discrete underlayment laths 12 that may be used in accordance with some embodiments of the present invention are illustrated. Each illustrated underlayment lath 12 includes an upper and lower surface 17, 19 and a plurality of spaced-apart fastener receiving passageways 15 configured to receive a bolt, screw or other type of fastener for securing a tactile warning mat 1 to the underlayment lath 12. The underlayment lath 12 of FIG. 4A has a flat bottom surface 19. The underlayment lath 12 of FIG. 4B has a bottom surface 19 with sinusoidal contours 21. The underlayment lath 12 of FIG. 4C has a bottom surface 19 with flat arched contours 23. The underlayment laths 12 of FIGS. 4B and 4C have an added benefit of requiring less raw material as a result of the contoured bottom surface 19.

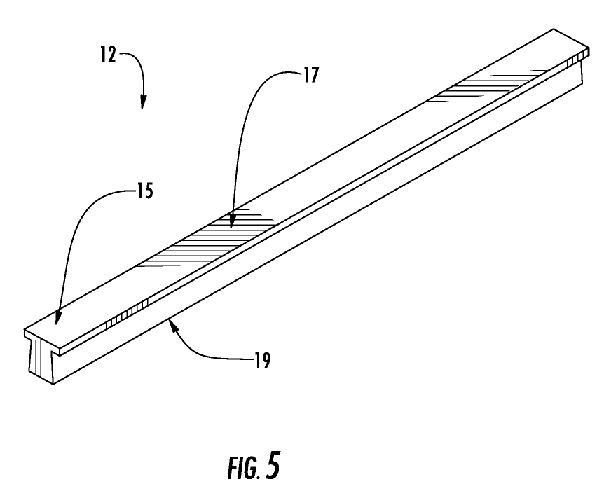

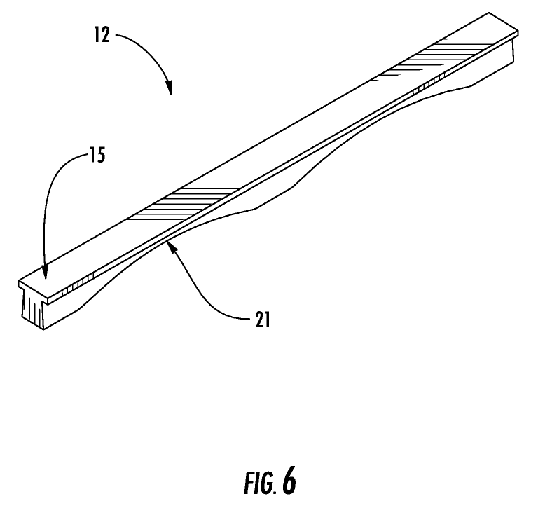

Referring to FIGS. 5 and 6, two different combinations of cross-sectional configurations and underlayment lath bottom surfaces are illustrated. FIG. 5 depicts an underlayment lath 12 with a flat bottom surface 19 and an inverted keystone cross-sectional configuration. FIG. 6 depicts an underlayment lath 12 with a bottom surface 19 having sinusoidal contours 21 and an inverted keystone cross-sectional configuration.

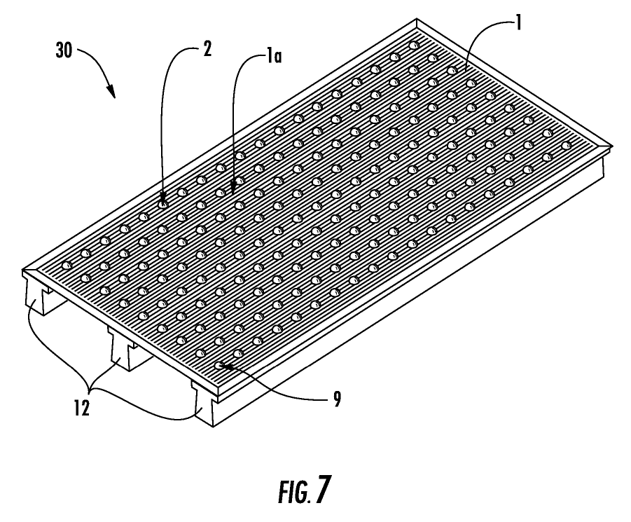

Referring to FIG. 7, a tactile warning mat system 30, according to some embodiments of the present invention is illustrated. The illustrated tactile warning mat system 30 includes a tactile warning mat 1 attached to three discrete underlayment laths 12, each having an inverted keystone cross-sectional configuration and a flat bottom surface 19.

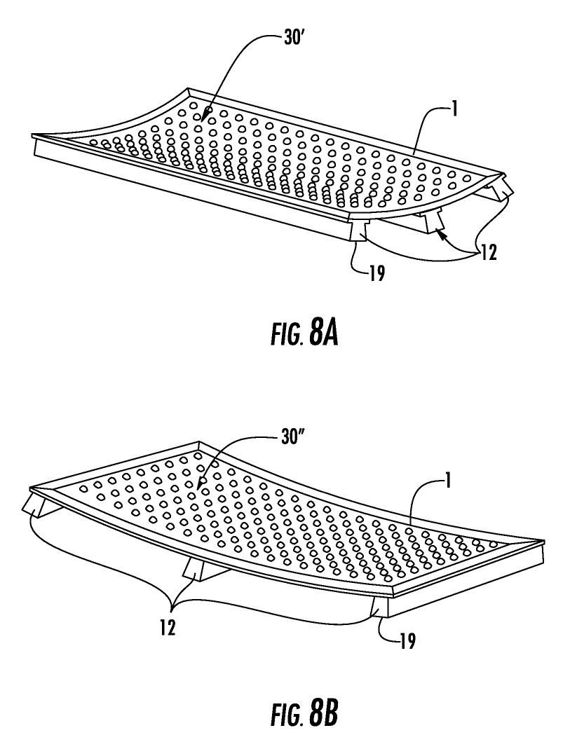

FIGS. 8A-8B illustrate respective tactile warning mat systems 30′, 30″ according to some embodiments of the present invention. In FIG. 8A, tactile warning mat system 30′ includes a tactile warning mat 1 removably attached to three discrete underlayment laths 12, each having an inverted keystone cross-sectional configuration and a flat bottom surface 19. In addition, the illustrated tactile warning mat system 30′ is depicted in a contorted state whereby the tactile warning mat 1 is arched or contoured across its width. In FIG. 8B, tactile warning mat system 30″ includes a tactile warning mat 1 removably attached to three discrete underlayment laths 12, each having an inverted keystone cross-sectional configuration and a flat bottom surface 19. In addition, the illustrated tactile warning mat system 30″ is depicted in a contorted state whereby the tactile warning mat 1 is arched or contoured across its length.

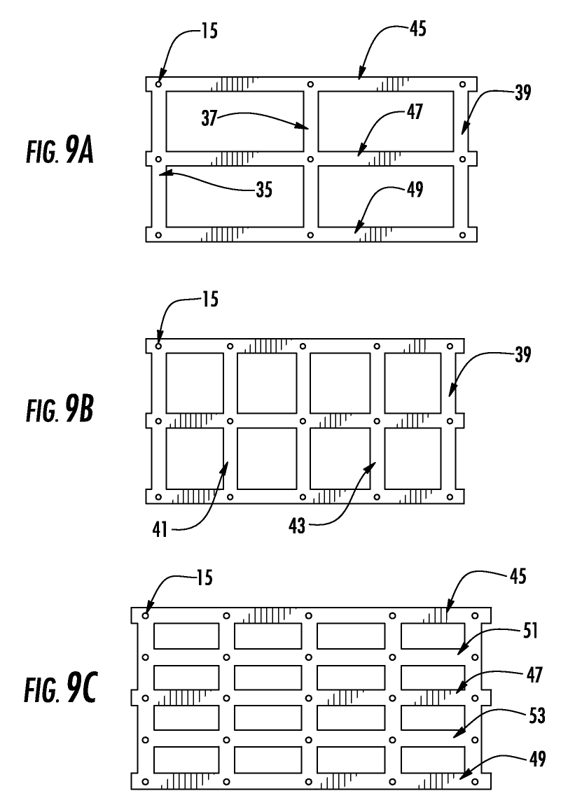

According to some embodiments of the present invention, a plurality of underlayment laths may be connected in various patterns to form a unitary structure, as illustrated in FIGS. 9A-9C. FIG. 9A is a top plan view of a unitary structure of first parallel, spaced-apart underlayment laths 35, 37, 39 and second parallel, spaced-apart laths 45, 47, 49. In FIG. 9B additional laths 41, 43 have been added to the structure of FIG. 9A to achieve additional stiffness and strength. In FIG. 9C additional laths 51, 53 have been added to the structure of FIG. 9B to achieve additional stiffness and strength.

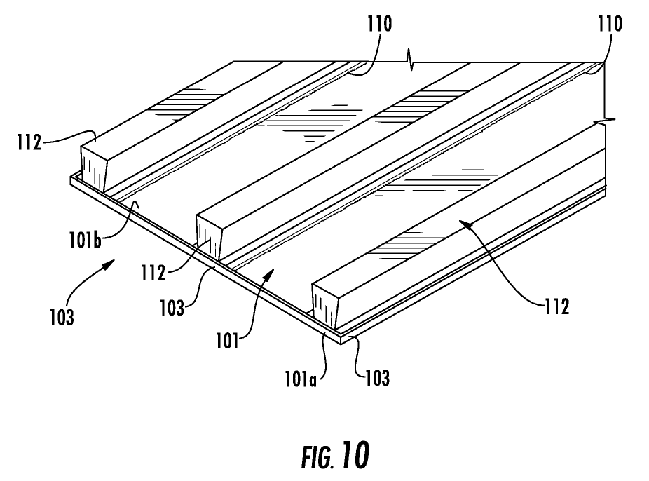

Referring to FIG. 10, a tactile warning mat system 130, according to some embodiments of the present invention is illustrated. The illustrated tactile warning mat system 130 includes a warning mat 101 having opposite top and bottom surfaces 101a, 101b, and a plurality of spaced-apart underlayment laths 112 removably secured to the warning mat 101, as described above. A lip 103 extends outwardly from the warning may bottom surface 101b adjacent the periphery thereof, as illustrated. The lip 103 is configured to prevent water penetration beneath the tactile warning mat 101 once it is embedded into concrete, asphalt or another substrate.

According to some embodiments of the present invention, a sealant material 110 is disposed between the tactile warning mat lower surface 102b and each underlayment lath upper surface. Alternatively, a sealant material 110 may be disposed in contacting, adjacent relationship with each underlayment lath 112 and the warning mat lower surface 102b, as illustrated in FIG. 10, to prevent the ingress of water through any gaps therebetween, as would be understood by those skilled in the art of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A tactile warning mat system for walkways, curbs, and other areas of pedestrian traffic, comprising:
a tactile warning mat having opposite upper and lower surfaces, wherein the upper surface includes a plurality of raised projections extending outwardly therefrom in a tactile pattern; and
a plurality of unconnected, elongated underlayment laths removably secured to the tactile warning mat lower surface in spaced-apart relationship, wherein the underlayment laths are adapted to be embedded within a walkway surface material, and wherein each underlayment lath has a cross-sectional configuration that locks the underlayment lath within the walkway surface material when cured.

2. The tactile warning mat system of claim 1, wherein each underlayment lath has a cross-sectional configuration selected from the group consisting of: a keystone, a trapezoid, and a parallelogram.

3. The tactile warning mat system of claim 1, wherein each underlayment lath has a planar upper surface that is in contacting relationship with the tactile warning mat lower surface.

4. The tactile warning mat system of claim 1, wherein each underlayment lath has a planar upper surface that is in contacting relationship with the tactile warning mat lower surface and a planar lower surface that is substantially parallel with the underlayment lath upper surface.

5. The tactile warning mat system of claim 1, wherein one or more of the underlayment laths has a lower surface with a contoured configuration that facilitates the removal of air trapped therebeneath when embedded within uncured walkway surface material.

6. The tactile warning mat system of claim 1, further comprising a plurality of spaced-apart, elongated ridges extending along the tactile warning mat upper surface, wherein the ridges define respective pathways within which water can flow around each of the raised projections and off of the tactile warning mat upper surface.

7. The tactile warning mat system of claim 1, wherein the tactile warning mat comprises a beveled peripheral edge portion that provides a smooth transition between the tactile warning mat upper surface and an adjacent walkway surface.

8. The tactile warning mat system of claim 1, wherein each underlayment lath comprises at least one fastener receiving passageway that terminates at the underlayment lath upper surface, wherein each fastener receiving passageway is configured to removably receive a respective fastener therein that extends through the tactile warning mat and removably secures the tactile warning mat to the underlayment lath.

9. The tactile warning mat system of claim 1, further comprising a lip extending outwardly from the tactile warning mat lower surface adjacent a periphery thereof, wherein the lip is configured to prevent the ingress of water beneath the tactile warning mat when the tactile warning mat system is installed in a walkway.

10. The tactile warning mat system of claim 1, further comprising sealant material disposed between the tactile warning mat lower surface and each underlayment lath upper surface, wherein the sealant material is configured to prevent the ingress of water therebetween.

11. The tactile warning mat system of claim 1, wherein the tactile warning mat has a non-planar, contoured configuration.

12. The tactile warning mat system of claim 1, wherein the underlayment laths comprise material selected from the group consisting of, thermosetting polymers, thermoplastic polymers, closed cell foam, fly ash concrete, and polymer concrete.

13. A tactile warning mat system for walkways, curbs, and other areas of pedestrian traffic, comprising:
a tactile warning mat having opposite upper and lower surfaces, wherein the upper surface includes a plurality of raised projections extending outwardly therefrom in a tactile pattern; and
a plurality of elongated underlayment laths interconnected to form a unitary structure, wherein the unitary structure is removably secured to the tactile warning mat lower surface, wherein the underlayment laths in the unitary structure are adapted to be embedded within a walkway surface material, and wherein each underlayment lath has a cross-sectional configuration that locks the underlayment lath within the walkway surface material when cured.

14. The tactile warning mat system of claim 13, wherein each underlayment lath has a cross-sectional configuration selected from the group consisting of: a keystone, a trapezoid, and a parallelogram.

15. The tactile warning mat system of claim 13, wherein each underlayment lath has a planar upper surface that is in contacting relationship with the tactile warning mat lower surface.

16. The tactile warning mat system of claim 13, wherein each underlayment lath has a planar upper surface that is in contacting relationship with the tactile warning mat lower surface and a planar lower surface that is substantially parallel with the underlayment lath upper surface.

17. The tactile warning mat system of claim 13, wherein one or more of the underlayment laths has a lower surface with a contoured configuration that facilitates the removal of air trapped therebeneath when embedded within uncured walkway surface material.

18. The tactile warning mat system of claim 13, further comprising a plurality of spaced-apart, elongated ridges extending along the tactile warning mat upper surface, wherein the ridges define respective pathways within which water can flow around each of the raised projections and off of the tactile warning mat upper surface.

19. The tactile warning mat system of claim 13, wherein the tactile warning mat comprises a beveled peripheral edge portion that provides a smooth transition between the tactile warning mat upper surface and an adjacent walkway surface.

20. The tactile warning mat system of claim 13, wherein each underlayment lath comprises at least one fastener receiving passageway that terminates at the underlayment lath upper surface, wherein each fastener receiving passageway is configured to removably receive a respective fastener therein that extends through the tactile warning mat and removably secures the tactile warning mat to the underlayment lath.

21. The tactile warning mat system of claim 13, further comprising a lip extending outwardly from the tactile warning mat lower surface adjacent a periphery thereof, wherein the lip is configured to prevent the ingress of water beneath the tactile warning mat when the tactile warning mat system is installed in a walkway.

22. The tactile warning mat system of claim 13, further comprising sealant material disposed between the tactile warning mat lower surface and each underlayment lath upper surface, wherein the sealant material is configured to prevent the ingress of water therebetween.

23. The tactile warning mat system of claim 13, wherein the tactile warning mat has a non-planar, contoured configuration.

24. The tactile warning mat system of claim 13, wherein the underlayment laths comprise material selected from the group consisting of, thermosetting polymers, thermoplastic polymers, closed cell foam, fly ash concrete, and polymer concrete.

25. A tactile warning mat system for walkways, curbs, and other areas of pedestrian traffic, comprising:
a tactile warning mat having opposite upper and lower surfaces, wherein the upper surface includes a plurality of raised projections extending outwardly therefrom in a tactile pattern, and a plurality of apertures formed therethrough;
a plurality of elongated underlayment laths removably secured to the tactile warning mat lower surface in spaced-apart relationship, wherein the underlayment laths are adapted to be embedded within a walkway surface material, wherein each underlayment lath has a cross-sectional configuration that locks the underlayment lath within the walkway surface material when cured, wherein each underlayment lath comprises at least one fastener receiving passageway that terminates at the underlayment lath upper surface and that is configured to removably receive a respective fastener therein; and
a plurality of fasteners extending through the tactile warning mat apertures and removably securing the tactile warning mat to the underlayment laths via the respective fastener receiving passageways.

26. The tactile warning mat system of claim 25, wherein one or more of the underlayment laths has a lower surface with a contoured configuration that facilitates the removal of air trapped therebeneath when embedded within uncured walkway surface material.

27. The tactile warning mat system of claim 25, further comprising a lip extending outwardly from the tactile warning mat lower surface adjacent a periphery thereof, wherein the lip is configured to prevent the ingress of water beneath the tactile warning mat when the tactile warning mat system is installed in a walkway.

28. The tactile warning mat system of claim 25, wherein the tactile warning mat has a non-planar, contoured configuration.

29. The tactile warning mat system of claim 25, wherein the plurality of elongated underlayment laths are interconnected to form a unitary structure.
